(19) United States
(12) Patent Application Publication
(10) Pub. No.: US 2008/0291972 A1
(43) Pub. Date: Nov. 27, 2008

(54) Method and Transmitter, Receiver and Transceiver Systems for Ultra Widebrand Communication

(75) Inventors: Francois Chin Po Shin, Singapore (SG); Appukuttan Nair Saraswathy Amma Madhukumar, Singapore (SG)

Correspondence Address: CONLEY ROSE, P.C.;David A. Rose, P. O. BOX 3267, HOUSTON, TX, 77253-3267, US

(73) Assignee: AGENCY FOR SCIENCE, TECHNOLOGY AND RESEARCH, Singapore (SG)

(21) Appl. No.: 10/597,344

(22) PCT Filed: Jan. 20, 2004
(86) PCT No.: PCT/SG2004/000021

§ 371 Date: Aug. 12, 2008

(51) Int. Cl. H04B 1/69

(52) U.S. Cl. 375/130; 375/E01.001

(57) ABSTRACT

A system such as a code division multiple access (CDMA) system or an ultrawide band (UWB) system comprises a transmitter and a receiver. The transmitter includes a sequence extender for extending the incoming signal and a spreader for spreading the extended signal, the spreader input being coupled to the sequence extender output. A pulse shaper is coupled to the spreader output to provide a transmitter output signal. The transmitter output signal which has an associated chip rate is received by the receiver and is passed to a filter to select a number of input signals from the received signals. The signal is the passed to a sequence extension remover for removing a number of chips from the signal. The received signal is despread to a symbol rate which is less than the chip rate at which the received signal was spread prior to being received by the receiver. A frequency domain equalizer is provided to form a frequency equalized signal from the modified signal.

### FIELD OF THE INVENTION

The present invention relates to a system, a transceiver structure for use therein and a method of processing signals in such a system. In particular, the invention relates to a cyclically extended CDMA system with frequency domain equalization,

### BACKGROUND OF THE INVENTION

Direct sequence code division multiple access (DS-CDMA), is one of the effective wireless access technologies for supporting high system capacity, variable and high data rate transmission services and it has been adopted in the 3^{rd} generation (3G) wireless communications systems.

Conventional DS-CDMA systems are single carrier transmission systems. Typically, there are two kinds of receivers for use in a DS-CDMA system, namely a RAKE receiver and a time-domain equalization (TDE) receiver. The performance of the receiver depends on the properties of the wireless environment. Due to multipath delay spread of the wireless channel in such systems, inter-finger interference (IFI) and multiple access interference (MAI) are inherent with Rake receivers. On the other hand, TDE receivers, although theoretically capable of suppressing IFI and MAI, suffer from slow convergence time and complicated computations when applied in DS-CDMA systems, and they are not able to suppress IFI and MAI effectively in practice. Thus, conventional single carrier DS-CDMA systems are associated with inter-finger interference (IFI) and multiple access interference (MAI), which limit the system capacity and the maximum data rate that can be supported for available bandwidth.

Multicarrier transmission schemes have been proposed as an effective way to improve channel capacity utilization under multipath interference and frequency selective fading reception by multipath delay suppression. Orthogonal frequency division multiplexing (OFDM) is an effective multicarrier modulation scheme to combat the frequency selectivity of the channel using a simple one-tap equalizer. OFDM prevents inter-symbol interference (ISI) and inter-carrier interference (ICI) by inserting a cyclic prefix (CP) between adjacent OFDM symbols. Moreover, the signal can be transmitted and received using fast Fourier transform (FFT) devices without increasing the transmitter and receiver complexities.

Uncoded OFDM transmission techniques applied in a multipath environment have a bit error rate (BER) comparable to that of a narrow band radio channel because the fading of each subcarrier is frequency non-selective. To overcome this behaviour and to reduce the BER, a combination of orthogonal frequency division modulation (OFDM) and CDMA, which is termed multicarrier CDMA (MC-CDMA), may be used to improve channel capacity utilization under multipath interference and frequency selective fading reception conditions by multipath delay suppression and diversity gain. MC-CDMA has been proposed as a candidate for future wireless communication systems.

In MC-CDMA systems, the energy of each information symbol is spread over several subcarriers, which leads to a diversity gain in a broadband-fading channel. However, even though this technology can support high data rate and multiple users, it suffers from two major implementation difficulties. The first is a high peak-to-average power ratio (PAPR) problem inherent with MC-CDMA systems and hence a highly linear (and inefficient) amplifier must be used to avoid distortion and spectral spreading. The second problem is a high sensitivity to frequency offset and RF phase noise. These conditions limit the applicability of MC-CDMA in practical wireless environments.

In the Applicant's co-pending U.S. patent application U.S. Ser. No. 10/090,370, published as 2003/0165131 A1, various technologies using the advantages of DS-CDMA and MC-CDMA are discussed and a single carrier cyclic prefix assisted CDMA system is proposed to overcome the disadvantages of DS-CDMA and MC-CDMA systems for high-rate data transmission. The described system uses a cyclic prefix to suppress inter-symbol interference (ISI) and multipath interference, independent data symbol spreading, and uses a single-tap chip-wise frequency domain equalizer at the receiver. As the described system uses single carrier transmission, the problems concerning peak-to-average power ratio (PAPR) and RF phase noise are minimal.

Various simulation studies on single carrier cyclic prefix assisted CDMA systems such as the system described in U.S. patent application U.S. Ser. No. 10/090,370, have shown significant performance improvement for downlink transmission (base station to mobile station) over alternate candidates. However, in systems such as those of the type described in U.S. Ser. No. 10/090,370 there is an assumption that all users are synchronized and share the same channel. In typical uplink transmission, all users are asynchronous to each other and use different wireless channels. Thus, the performance of systems such as that described in U.S. Ser. No. 10/090,370 will be adversely affected. In such cases efficient multi-user detection algorithms with high computational complexity are required for the performance improvement to provide an acceptable quality of service (see, for example, K. Yang, A. S. Madhukumar, and F. Chin, “Multistage Interference Cancellation with Frequency Domain Equalization for Uplink Transmission of Single Carrier Cyclic Prefix Assisted CDMA System”, In Proceedings of the IEEE Wireless Communications and Networking Conference, March 2002).

In view of the above-mentioned problems, there is a need for a transceiver structure for use in VSF-OFCDM time domain spreading systems that minimises the requirements of multi-user detection procedures for uplink transmission without compromising the system capacity.

### SUMMARY OF THE INVENTION

According to a first aspect of the invention there is provided a transceiver system comprising:
at least one receiver for receiving one or more signals from one or more transmitters, said one or more received signals having an associated chip rate, said receiver having:
at least one filter for selecting one or more input signals from the received signals;
a sequence extension remover for removing a predetermined number of chips from at least one predetermined position of said received signal to form a modified signal;
a despreader arranged to despread said received signal to a symbol rate, said symbol rate being less than said chip rate at which said received signal was spread prior to being received by said receiver, the ratio of the spread rate to the symbol rate being the processing gain of the receiver; and
a frequency domain equalizer for forming a frequency equalized signal from said modified signal.

Thus, in this preferred embodiment, the frequency domain equalizer operates at the symbol rate, which is particularly advantageous as the symbol rate is less than the chip rate and therefore the system requires less power to operate.

Preferably, said despreader is arranged to despread said received signal on a block-by-block basis.

In a first preferred embodiment, the sequence extension remover has an input for receiving one or more signals output from said at least one filter, and said sequence extension remover has an output coupled to an input of said despreader. This is particularly advantageous as the frequency domain equalizer will operate at the symbol rate which is less than the chip rate thereby reducing the computational load and/or power consumption of the system, without compromising system performance.

In an alternative preferred embodiment, said despreader has an input for receiving one or more signals output from said at least one filter, and said despreader has an output coupled to an input of said sequence extension remover. This is particularly advantageous as the sequence extension remover, as well as the frequency domain equalizer will operate at the symbol rate which is less than the chip rate thereby reducing the computational load and/or power consumption of the system, without compromising system performance.

In a preferred embodiment, said at least one transmitter comprises:
at least one spreader for spreading a data packet having one or more blocks to derive a spread sequence for each of said blocks to form a spread signal, said spreader having an input and an output;
a sequence extender for extending each of said blocks using a predetermined number of chips to form an extended spread signal, said sequence extender being coupled to the output of the spreader, said sequence extender having an input and an output; and
a pulse shaper coupled to the output of said sequence extender.

Thus, in a preferred embodiment, the data is spread in blocks rather than each data symbol being spread independently as is the case in conventional systems such as that described in the applicants' co-pending patent application U.S. Ser. No. 10/090,370.

In an alternative further preferred embodiment, said at least one transmitter comprises:
a sequence extender for extending each of a number of blocks in an incoming signal using a predetermined number of chips to form an extended signal, said sequence extender having an output and an input, said incoming signal comprising at least one data packet;
at least one spreader for spreading said extended signal to derive a spread sequence for each of said blocks to form a spread signal, said spreader having an input and an output, said input of said spreader being coupled to said output of said sequence extender; and
a pulse shaper coupled to the output of said spreader to provide a transmitter output signal.

According to a further aspect of the present invention there is provided a method for transmitting signals, said method comprising the steps of:
spreading, by at least one spreader, a data packet having one or more blocks to derive a spread sequence for each of said blocks and to form a spread signal;
extending, by a sequence extender, each of said blocks in said spread signal using a predetermined number of chips to form an extended spread signal, said spread signal being received from a spreader output of said at least one spreader; and
shaping, by a pulse shaper coupled to an output of said sequence extender, said extended spread signal.

According to another aspect of the present invention there is provided a method for transmitting signals, said method comprising the steps of:
extending, by a sequence extender, each of a number of blocks in an incoming signal using a predetermined number of chips to form an extended signal, said incoming signal comprising at least one data packet;
spreading, in at least one spreader, said extended signal received from an output of said sequence extender to derive a spread sequence for each of said blocks to form a spread signal; and
shaping, in a pulse shaper, said spread signal received from an output of said at least one spreader to provide a transmitter output signal.

According to another aspect of the present invention there is provided a method for processing a received signal comprising the steps of:
receiving one or more signals from one or more transmitters, said one or more received signals having an associated chip rate;
selecting, using at least one filter, one or more input signals from the received signals;
removing, in at least one sequence extension remover, a predetermined number of chips from at least one predetermined position of said received signal to form a modified signal;
despreading, in at least one despreader, said received signal to a symbol rate, said symbol rate being less than said chip rate at which said received signal was spread prior to being received by said receiver, the ratio of the spread rate to the symbol rate being the processing gain of the receiver; and
forming, in at least one frequency domain equalizer, a frequency equalized signal from said modified signal.

Preferably, said step of removing said sequence extension is before said despreading step and after said selecting step.

In a further preferred embodiment, said despreading step is before said step of removing said sequence extension and after said selecting step.

According to another aspect of the present invention there is provided a code division multiple access (CDMA) system comprising at least one transceiver system of the type defined above.

According to a further aspect of the present invention there is provided an ultrawide band (UWB) system comprising at least one transceiver system of the type defined above.

The above-defined methods and systems embodying the present invention are applicable, for example, to cyclic extended single carrier CDMA systems and UWB systems at very high data rate. The pulse shaping function at the transmitter and the matched filter at the receiver will be dependent on the transmission method being used.

### BRIEF DESCRIPTION OF THE DRAWINGS

Preferred features of the invention will now be described, for the sake of illustration only, with reference to the following Figures in which:

FIG. 1a is a schematic block diagram of a transmitter according to an embodiment of the invention;

FIG. 1b is a block diagram of the data packet structure in the transmitter of FIG. 1a before and after the block spreading module;

FIG. 2 is a schematic diagram showing a block of the data packet structure with cyclic extension according to an embodiment of the invention;

FIG. 3 is a schematic diagram of a combined received signal for cyclic extended asynchronous transmission through an ideal channel according to an embodiment of the invention;

FIG. 4a is a schematic diagram showing a block of the data packet structure after parallel-to-serial conversion according to an embodiment of the invention;

FIG. 4b is a schematic diagram of a time prioritised spreading module after the insertion of a cyclic prefix according to an embodiment of the invention;

FIG. 5 is a schematic block diagram of a receiver according to an embodiment of the invention;

FIG. 6 is schematic diagram showing the block despreading procedure for a user according to an embodiment of the invention;

FIG. 7 is a schematic block diagram of a transmitter according to an alternative embodiment of the invention and also shows a block diagram of the data packet structure in the transmitter before and after the block spreading module;

FIG. 8a is schematic block diagram of a receiver according to an alternative embodiment of the invention;

FIG. 8b is schematic diagram showing the block despreading procedure for a user according to an alternative embodiment of the invention;

FIG. 9 is a schematic diagram showing the effect of multiple access interference (MAI) according to an embodiment of the invention;

FIG. 10 is a schematic diagram showing the effect of multiple access interference (MAI) for asynchronous users, according to an embodiment of the invention;

FIG. 11 is a block diagram of the time domain channel response estimation and the frequency domain equalization according to an embodiment of the invention;

FIG. 12a is a waveform of the pulse just before transmission through an UWB system, according to an embodiment of the invention; and

FIG. 12b is a waveform of a received pulse for single pulse transmission without channel distortion, according to an embodiment of the invention.

### DETAILED DESCRIPTION OF PREFERRED EMBODIMENTS

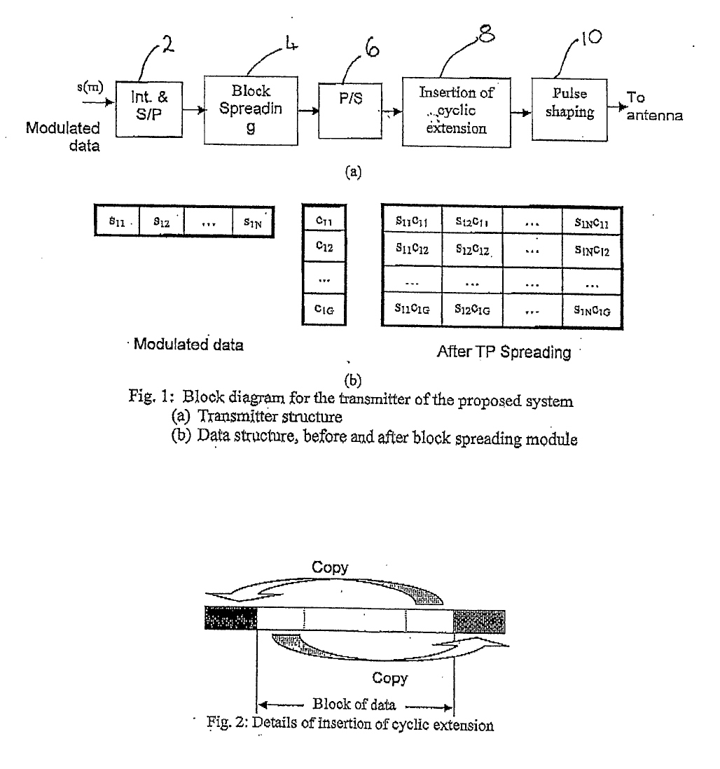

FIG. 1a shows the transmitter structure and FIG. 1b shows the packet structure of data being transmitted according to a first embodiment of the present invention. As shown in these figures, the modulated data symbols s(m) from a first user are firstly converted from a serial sequence into a parallel sequence in a serial-to-parallel converter 2. An interleaver (indicated as Int. in the figure) is optionally added before the serial-to-parallel conversion to interleave signals from other users with the signal of the first user. The parallel sequence is then passed to a block spreader 4 and block spreading is applied to the sequence. The spread signal is then passed through a parallel-to-serial converter 6. A cyclic extension is then inserted into each block in the serial sequence in a cyclic extension insertion module 8. The cyclically extended signal is then subjected to pulse shaping in a pulse shaper block 10 and, after RF conversion, the signal is transmitted through a wireless channel.

As shown in FIG. 1b, the vector s1 (=s₁₁, s₁₂, . . . , s_{1N}) denotes the modulated data symbols and c1 (=c₁₁, c₁₂, . . . , c_{1G}) is the spread code vector for the first user, hereinafter known as user 1. Each spreading module takes N data symbols together and will generate a spread matrix of a size N×G, where G is the length of the spread code vector (spreading factor).

Block spreading, is a form of time-prioritised (TP) spreading, in which G chips are placed over consecutive single-carrier symbols. A similar spreading method has been suggested for multicarrier systems in H. Atarashi, N. Maeda, S. Abeta, M. Sawshashi, “Broadband packet wireless access based on VSF-OFCDM and MC/DS-CDMA”, In Proceedings of the 13^{th} IEEE International Symposium on Personal, Indoor and Mobile Radio Communications, Vol. 3, pp. 992-997, 2002. It is different from frequency domain spreading in conventional MC-CDMA systems where G chips are placed in adjacent subcarriers of the same multicarrier symbol.

The dynamic range of spreading factor in block spreading is limited by the number of single carrier symbols in a spreading block (or frame). Compared with frequency domain variations, channel variations are negligible in the time domain for the duration of one spreading block (which is of the order of microseconds) and hence the code orthogonality for block spreading for high rate systems is maintained. It also implied in the above-mentioned document H. Atarashi, N. Maeda, S. Abeta, M. Sawshashi, “Broadband packet wireless access based on VSF-OFCDM and MC/DS-CDMA”, that the inter-code interference is smaller in block spreading, which is advantageous for multi-level modulation, such as 16QAM. In order to improve throughput, the application of adaptive modulation and channel coding are indispensable, which also includes multilevel modulation. Thus, TP spreading (block spreading) will be seen to be superior to frequency domain spreading, especially for high-rate systems.

The spread matrix generated by the block spreading module is converted into a serial stream of G single-carrier blocks, each of size N chips in the parallel-to-serial converter. This ensures that a necessary condition for block spreading is met, namely, that the chips corresponding to the same symbol are positioned in consecutive single carrier symbols.

As the spreading (and subsequent despreading) is performed on a block of data rather than on individual symbols, the spread code vector c1 is the same for all symbols in a block, so the spread code sequence is fixed for all symbols in a block although the data symbols may vary throughout the block. Furthermore, as the spreading (and subsequent despreading) is performed using parallel sequences of both the symbol and the spread codes, each symbol may be spread (and despread) in a single operation. In other words, while a conventional spreader (and despreader) runs the chip sequence at higher rate than the symbol sequence, the proposed block spreader (and block despreader) runs the symbol sequence at higher rate than the chip sequence. This is in contrast to conventional systems such as that described in U.S. patent application Ser. No. 10/090,370 in which individual symbols are spread (and despread) in series with a serially applied spreading (and despreading) code. After spreading, each block-spread data is appended with cyclic extension to remove any possible inter-block interference caused by the delay spread of the multipath channel. During despread, the spread data corresponding to a block spreading module is stacked together from the received signal, after the removal of cyclic extension. To despread, each row is multiplied with the corresponding chip of the user's spread code and added row-wise. Assuming the channel remains constant for spread block, the resulting output of despread block is a close approximate of the convolved output of transmitted symbols with user's channel parameters. It can be input to a symbol-wise channel equalizer. This procedure will significantly reduce the computational complexity for a multi-user system compared to that of conventional systems such as that described in U.S. Ser. No. 10/090,370, thereby reducing power consumption.

Furthermore, in a preferred embodiment of the invention, the spread code vector c1 changes more slowly than the symbol rate, although the chip rate is higher than the symbol rate.

During insertion of the cyclic extension, a fixed number of tail bits (chips) are added to the beginning of the block (to constitute a cyclic prefix) and a fixed number of header chips are appended at the end of each block (to constitute a cyclic postfix) as shown in FIG. 2. Such a procedure is described in detail in R. Morrison, L. J. Cimini (Jr), S. K. Wilson, “On the use of a cyclic extension in OFDM”, In Proceedings of the 54^{th} IEEE Vehicular Technology Conference, VTC 2001 Fall, Vol. 2, pp. 664-668, 2001.

For multi-user cases, cyclic extension will keep a perfect orthogonality among received signals, irrespective of the late or early arrival of received signals from different users. This is described in S. Tsumura and S. Hara, “Design and performance of quasi-synchronous multi-carrier CDMA system”, In Proceedings of the 54^{th} IEEE Vehicular Technology Conference, VTC 2001 Fall, Vol. 2, pp. 843-847, 2001, and is in contrast to the condition in systems in which the signals have only a cyclic prefix.

In multi-user cases, where the signals have a cyclic extension, the variation in arrival time of the received signals from different users is limited to the duration of the cyclic prefix/cyclic postfix. In practice, the lengths of the cyclic prefix and the cyclic postfix are equal and the sum is approximately one quarter of the length of the data block.

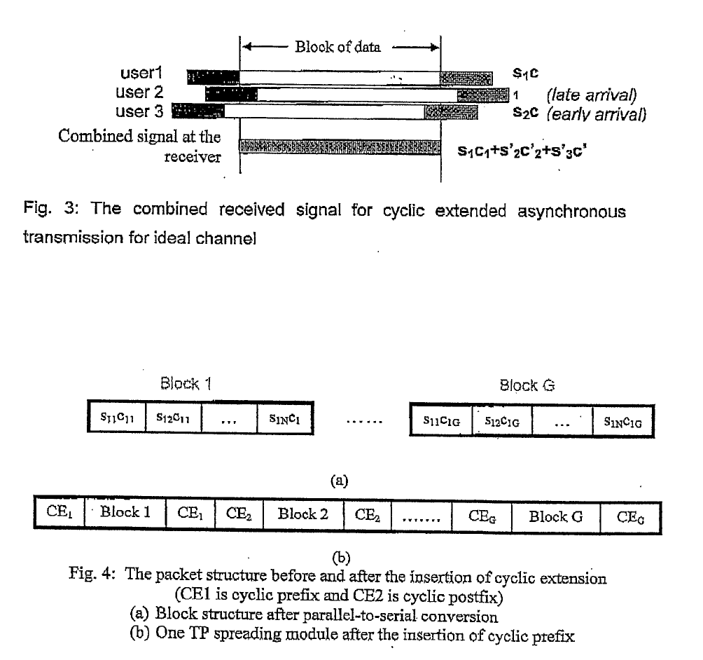

The combined received signal for a multi-user case (three users) for an ideal channel is shown in FIG. 3 which illustrates the received signal portion after removing the cyclic extension.

The presence of a cyclic extension removes any inter-block interference caused by the delay spread of the multipath channel. The length of the cyclic extension is usually chosen to be larger than the expected delay spread. This also ensures a convolution cyclic, which is a precondition for the frequency domain equalization at the receiver.

The output of the parallel-to-serial conversion and the subsequent insertion of a cyclic extension are shown in FIGS. 4a and 4b respectively. The cyclically extended data blocks are then transmitted through a wireless channel after pulse shaping and RF conversion.

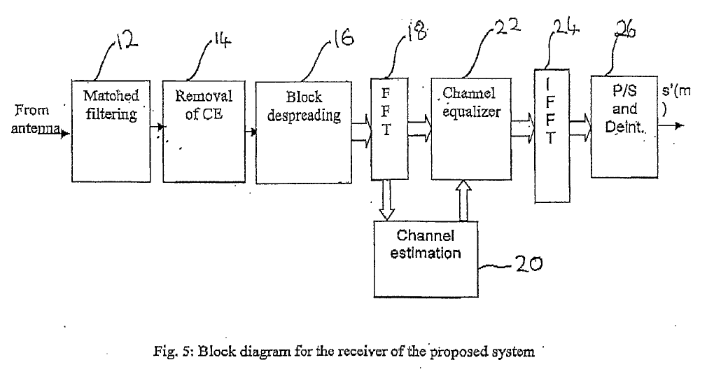

FIG. 5 shows the details of a receiver structure according to a first embodiment of the invention for processing the signals received from a transmitter, for example a transmitter of the type illustrated and described above in respect of FIGS. 1a to 4b. The received signal is processed firstly through a filter 12 matched to the pulse shaping filter in the transmitter to shape the pulse. Next, the cyclic extension is removed in a removal module 14 and the signal is stacked up in a block despreader module 16, block-by-block corresponding to a block-spreading matrix (G blocks, as discussed above in respect of FIG. 1b). The signal is then despread in the despreader module 16. The despread output (at symbol rate) is passed to a frequency domain equalization module, comprising a Fast Fourier Transform (FFT) module 18, a channel estimation module 20, a channel equalization module 22, also known as a frequency domain equalizer, and then to an Inverse Fast Fourier Transform (IFFT) module 24. The signal is then processed in a parallel-to-serial converter 26 to convert it from a parallel sequence to a serial sequence. Depending on the transmitter structure, an optional deinterleaver (Deint. in the figure) may be used to process the serially converted data before channel decoding, if any. The serially converted output will be a close approximation of the transmitted signal s(m).

The receiver structure assumes perfect synchronization of the data. More details of block despreading and frequency domain equalizers are discussed in the following paragraphs. Any standard conventional channel coding and decoding methods may be used together with the transceiver structure described in respect of FIGS. 1a to 5.

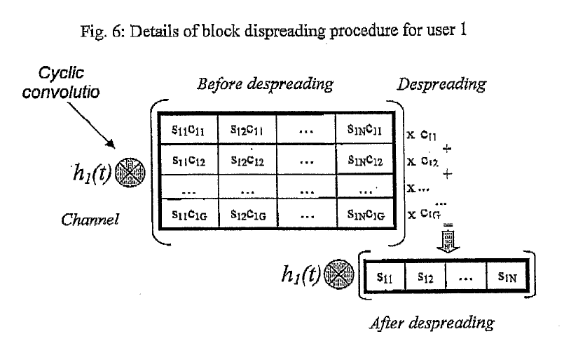

FIG. 6 shows the details of the block despreading procedure. The input data for the despreading module is the convolved outputs of the chip blocks with the channel vector corresponding to user 1 (h₁(t)) without cyclic extension. Spread data corresponding to a block spreading module (shown in FIG. 1b) is stacked together after the removal of the cyclic extension. It has G (length of spread code) rows and N (length of each single-carrier block) columns. To despread, each row is multiplied with the corresponding chip of the user's spread code and added row-wise. Assuming the channel remains constant for each time-prioritised (TP) spreading module, the resulting output of the TP despreading procedure is a close approximation of the convolved output of the transmitted symbols with the user's channel parameters. The resulting output of the TP despreading procedure may be input to a symbol-level channel equalizer.

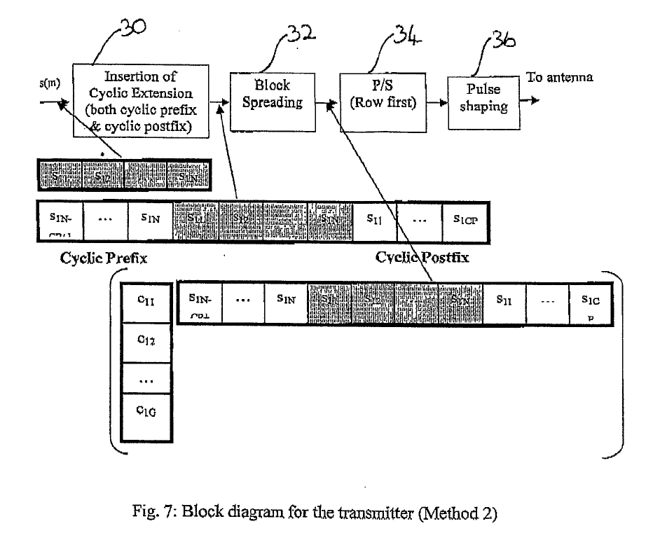

FIG. 7 shows a block diagram for a transmitter structure according to a second embodiment of the present invention. The transmitter comprises a cyclic extension insertion module 30 for receiving the modulated data symbols s(m) from a first user. The output, in parallel form, is fed to a block spreading module 32, and the output signal of the block spreader module 32 is converted from a parallel sequence into a serial sequence in a parallel-to-serial converter 34. The serial sequence is then passed to a pulse-shaping filter 36 before transmission. In a preferred embodiment, an interleaver (not shown) may optionally be added before the cyclic insertion module to interleave signals from other users with the signal of the first user.

FIG. 7 also shows the packet structure of data being transmitted according to the second embodiment of the present invention. As described above in respect of FIG. 1b, the vector s1 (=s₁₁, s₁₂, . . . , s_{1N}) denotes the modulated data symbols and c1 (=c₁₁, c₁₂, . . . , c_{1G}) is the spread code vector for the first user, hereinafter known as user 1. Each spreading module takes N data symbols together and will generate a spread matrix of a size N×G, where G is the length of the spread code vector (spreading factor).

The basic difference between the transmitters illustrated in FIGS. 1a and 7 is the position of the cyclic extension insertion block. In FIG. 1a, the cyclic extension is added after the block spreading. However, in the embodiment shown in FIG. 7, the cyclic extension is added before spreading, which reduces the number of times cyclic extension needs to be copied for one block-spreading module. On the other hand, the number of data symbols to be spread is increased in the embodiment of FIG. 7.

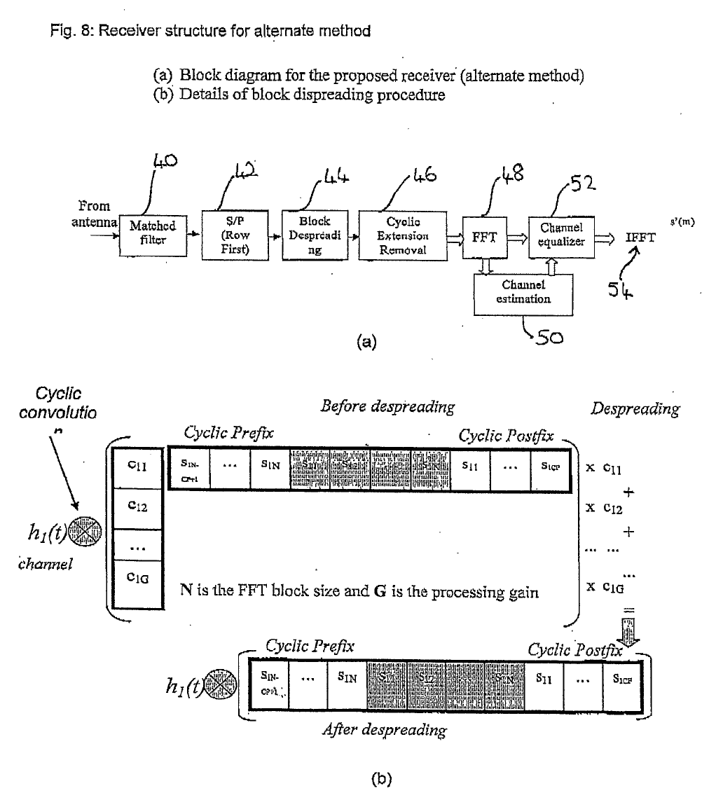

FIG. 8a shows an alternative receiver structure to the structure given in FIG. 5, for use with the transmitter of FIG. 7, according to a second embodiment of the present invention. FIG. 8b shows the details of the block despreading procedure for the alternate receiver of FIG. 8a and may be compared with FIG. 6.

In the receiver shown in FIG. 8a, the received signal is processed firstly through a filter 40 matched to the pulse shaping filter 36 in the transmitter, to shape the pulse. The signal is then processed in a serial-to-parallel converter 42 to convert it from a serial sequence to a parallel sequence. Next, the signal is stacked up in a block despreader module 44, block-by-block corresponding to a block-spreading matrix (G blocks, as discussed above in respect of FIG. 1b). The signal is then despread in the despreader module 44. The despread output (at symbol rate) is passed to a cyclic extension removal module 46 where the cyclic extension is removed. It is then passed to a frequency domain equalization module, comprising a Fast Fourier Transform (FFT) module 48, a channel estimation module 50, a channel equalization module 52 (also known as a frequency domain equalizer), and then to an Inverse Fast Fourier Transform (IFFT) module 54. The signal is then processed to convert it from a parallel sequence to a serial sequence. Depending on the transmitter structure, an optional deinterleaver (not shown) may be used to process the output from the frequency domain equalizer.

The signal obtained from the receiver according to the second embodiment which is illustrated in FIG. 8a, should be identical to that obtained by the receiver structure illustrated in FIG. 1a despite the fact that the cyclic extension removal is done after block despreading in the receiver of FIG. 8a.

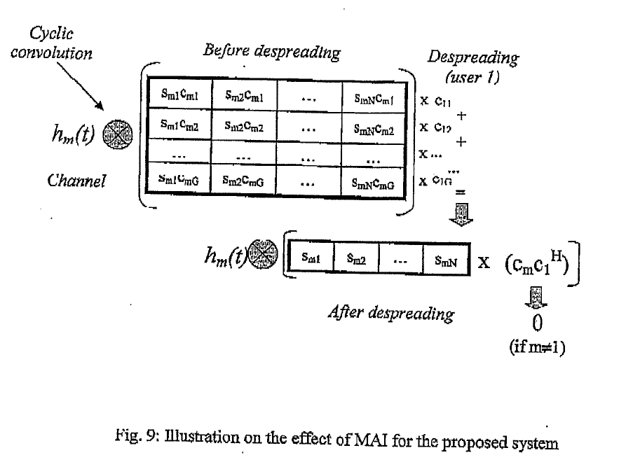

One of the advantages of the systems embodying the present invention is the robustness of the systems against multiple access interference (MAI) which may occur when there is more than one user operating. This is represented pictorially in FIG. 9.

In an uplink receiver with multiple users, sₘ (=sₘ₁, sₘ₂, . . . , s_{mN}) denotes the symbol vector and cₘ (cₘ₁, cₘ₂, . . . c_{mG}) the spread code vector for m^{th} user. It is assumed, for the sake of example only, that this user is an interfering user for user 1. Channel parameters are different for each user in the uplink. The channel parameters for the m^{th} user may be represented by hₘ(t). FIG. 6 shows the despreading operation for user 1. During despreading for user 1, the interfering user will be processed as shown in FIG. 9. Ignoring white noise, and considering orthogonal codes for each user, it gives minimal MAI as shown in FIG. 9.

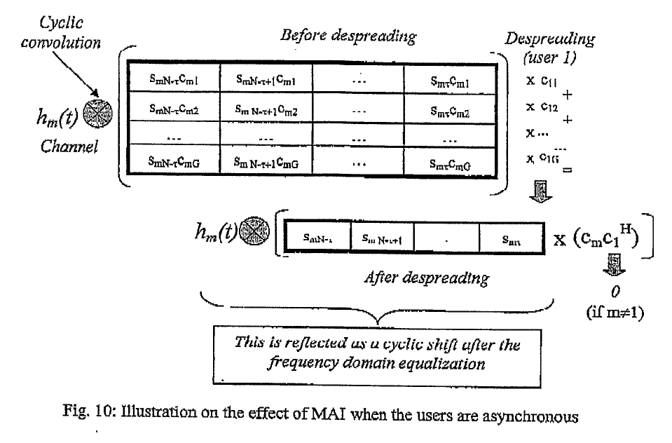

During, for example, uplink transmission, the interfering user will usually be asynchronous with the desired user. FIG. 10 shows the case where the interfering user is delayed by symbols (is an amount less than the cyclic prefix/postfix as discussed earlier). The interfering signal will still despread, but the symbols will not be time-aligned with the symbols from user 1. Furthermore, if the time misalignment is less than the symbol period, the spread codes might not be perfectly orthogonal. This leads to a small correlation value during despreading, which might introduce MAI. Furthermore, MAI is completely eliminated if BS-specific long code and MS-specific short codes are employed as the uplink code allocation scheme.

High data rate mobile radio channels in indoor or micro-cellular environments can exhibit large relative time dispersions due to multipath propagation. The characteristics of the received signal in such systems will vary with time and these characteristics may be estimated with the help of pilot symbols. The pilot symbols are periodically inserted within each TP spreading module. The required frequency of the pilot symbols depends on the velocity of the temporal variation of the channel causing the variations in the received signal. The variations in the channel may be estimated using channel estimation methods and equalized using a frequency domain equalization structure to reduce the receiver complexity and to take advantage of the frequency diversity. The variations in the channel may be estimated from either the frequency response or the time response of the received signal. From analytical studies and simulation results, it has been observed that the estimation of time response channel parameters from the frequency domain channel gives a better estimation accuracy than the direct estimation of the frequency domain channel. In view of this, the systems and methods embodying the present invention preferably use time domain estimation.

Unlike conventional multicarrier systems, the systems and methods embodying the present invention despread the incoming signal before equalization and hence the channel equalizer is simplified for symbol-wise operation. Also, despreading before equalization averages out (minimises) the effect of white noise within a TP spreading module. However, the removal of the cyclic extension will result in the reduction of received symbol energy. This will affect the system performance. Code orthogonality between multiple users during despreading will give better performance for multi-user systems, even if they use different wireless channels.

The channel response in the frequency domain may be estimated by solving a system equation with N equations and N unknowns. However, the channel response (h(l), where l=1, 2, . . . L) is physically sampled in time, so the number of parameters needing to be estimated is equal to the channel length L, which is much less than the number of subcarriers N.

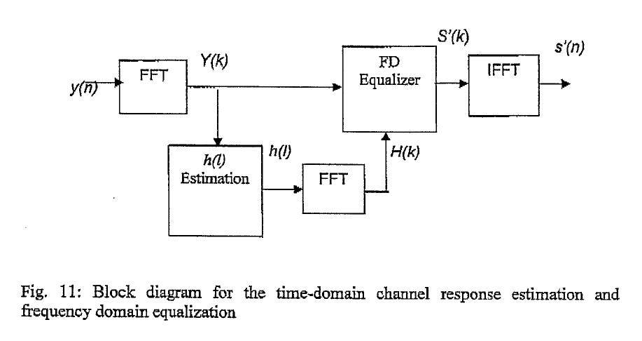

The received signal for the k^{th} subcarrier in the frequency domain (Y(k)) is

$$Y ( k ) = H ( k ) S ( k ) + W ( k ) = {\sum }_{l = 0}^{L - 1} h ( l ) {e}^{( - j2π \frac{lk}{N} )} S ( k ) + W ( k )$$

where H(k) is the frequency domain channel, S(k) represents the frequency domain pilot symbols and W(k) represents the frequency domain noise components. There are N equations and L unknowns (L<<N). Hence it is possible to formulate matrix equations from which the time response function of the channel h(n) may be determined. FIG. 11 shows a block diagram corresponding to this estimation method and subsequent frequency domain (FD) equalization.

In FIG. 11, the time domain signal y(n) output from the despreading module of the receivers shown in FIGS. 5 and 8 may be Fast Fourier Transformed to the frequency domain to give the signal Y(k). This signal Y(k) is then passed to the estimation module and also to the frequency domain equalizer module. The estimation module derives the channel response h(l) in the time domain. This channel response is then Fast Fourier Transformed to produce the estimated channel response H(k) in the frequency domain. The estimated channel response H(k) in the frequency domain then operates on the frequency domain signal in the frequency domain equalizer module to produce the equalised signal in the frequency domain S′(k). The equalised signal S′(k) is then transformed in an Inverse Fast Fourier Transform (IFFT) module into the time domain to give the output signal s′(n).

In the equalizer module, conventional methods for channel equalization, such as maximum ratio combining (MRC), equal gain combining (EGC), orthogonality restoring combining (ORC) and minimum mean square error combining (MMSEC) may be used. These methods are discussed in detail in S. Hara and R. Prasad, “Design and performance of multicarrier CDMA system in frequency-selective Rayleigh fading channels”, IEEE Transactions on Vehicular Technology, vol. 48, no. 5, pp. 1584-1595, September 1999, the disclosure of which is incorporated herein by reference.

The required properties of the pulse shaping filter in the transmitter systems illustrated in FIGS. 1a and 7 and the matched filter in the receiver systems illustrated in FIGS. 5 and 8, will depend on the properties of the communication systems being used.

For DS-CDMA systems, the pulse shaping filter and the matched filter are a matched filter pair and are used as in conventional systems with a specified roll-off factor. The matched filter units in the receiver for those cases will be similar to the transmitter pulse-shaping filter.

The systems and methods embodying the present invention may also be used in ultra-wideband (UWB) systems, where the channel capacity scales almost linearly with bandwidth. UWB communication systems are based on the generation and transmission of very short pulses in the time domain, for example in the range of a few tens of Picoseconds or a few nanoseconds, resulting in bandwidths of a few GHz (Giga hertz) in the frequency domain. A very high data rate signal may be supported by UWB due to its large bandwidth, however, the power spectral density of UWB systems is extremely low, even below the noise floor.

The short UWB waveforms are relatively immune to multipath effects. In conventional communication systems, the arrival of reflected waves with different path lengths causes constructive and destructive interference at the receiver, degrading the system's performance. With very short pulses, these reflected waves arrive without interfering with each other. These multipath components can be resolved, and a simple frequency domain equalizer can effectively collect the multipath energies.

Designing a transceiver structure for high-rate systems with unlimited bandwidth such as UWB is a challenging task. Complex design issues related to both radio frequency (RF) and baseband signal processing of both the transmitter and the receiver must be considered. Embodiments of the present invention described above and illustrated in FIGS. 1a to 11 may be used for ultra-high data rate transmission in the UWB range, using the principles of a cyclically extended single carrier CDMA system with frequency domain equalization.

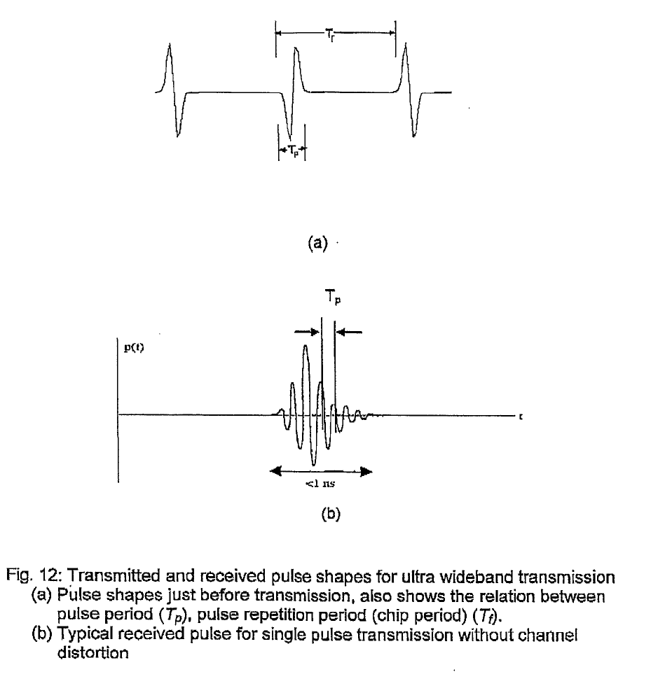

For ultra wideband systems, the incoming modulated data signal s(m) is transmitted as wideband pulses followed by a silent period. The pulse repetition period for such transmission is equal to the chip period. FIG. 12(a) shows an example of UWB pulse transmission.

The receiver for UWB transmission should be able to capture the maximum amount of energy from the transmitted pulse. FIG. 12b shows the typical shape of the waveform received at the receiver when a UWB pulse is transmitted and has not undergone any channel distortion. As will be seen from FIG. 12b, the received pulse resembles a ringing or oscillating pattern, having roughly equal durations of positive and negative excursions (periods of “ups and downs”). The period of the excursions may be termed as pulse width (Tₚ), as is noted in FIG. 12b. This property of the received pulse is important and indicates that the best option for efficiently capturing the maximum energy from the transmitted pulse is to design a matched filter which is matched to the received pulse shape.

An efficient and practical implementation for such a received matched filter is a sinusoidal waveform, which is essentially a local oscillator (LO) with a centre frequency equal to the inverse of the pulse width (1/Tₚ) of the transmitted pulse, followed by a low-pass filter of roughly the same bandwidth. In practice, such a local oscillator might introduce a timing mismatch, which can be compensated by using a quadrature pair of local oscillators.

In summary, the invention proposes transceiver systems and methods which may be used for both wideband and ultra wideband systems. The systems and methods embodying the invention are robust against multipath delay spread and IFI and are less complicated than time domain equalization (TDE) systems. Furthermore, the complexity of the systems and methods embodying the invention does not change significantly with the length of channel response.

The systems and methods embodying the invention aim to minimise or completely eliminate problems which complicate conventional multicarrier systems, such as the peak-to-average power ratio and sensitivity to phase noise and frequency offset. Furthermore, MAI is completely eliminated if BS-specific long code and MS-specific short codes are employed as the uplink code allocation scheme. The systems and methods embodying the invention may be implemented with simple hardware at the mobile station (MS) and the base station (BS). At the mobile station (MS), the transmitter may include a simple DS-CDMA transmitter, without a FFT module as this may now be incorporated in the base station (BS). Also, constant modulus transmission may be used which is cheaper and more efficient in power usage as there are no problems with the peak-to-average power ratio (PAPR).

At the base station (BS) receiver, a low-complexity single-tap symbol-level equaliser may be employed to provide improved performance over conventional systems. The single-tap symbol-level equalizer simplifies the receiver structure. The systems and methods embodying the present invention aim to harness all the received energy from the multipath channel as the received signal is processed in the frequency domain.

The systems and methods embodying the present invention provide an effective method of handling asynchronous transmission (Quasi-symbol synchronous) between multiple users during uplink transmission.

Embodiments of the present invention may have a particular use in the uplink transmission of 4^{th} Generation (4G) wireless communication systems, in place of conventional MC-DS/CDMA systems which use multiple RAKE receivers for each subcarrier and therefore are likely to suffer from severe performance degradation in high-rate systems with multiple users.

Embodiments of the present invention may also be used as an ultra wideband transceiver structure for high-rate systems using time-prioritised spreading and symbol-level frequency domain equalization. In such ultra-wideband systems, channel variations will be minimal with respect to packet duration.

Also, the systems and methods embodying the present invention may have a particular use in 802.15.3 high rate WPAN systems.

Various modifications to the embodiments of the present invention described above may be made. For example, other modules and method steps can be added or substituted for those above. Thus, although the invention has been described above using particular embodiments, many variations are possible within the scope of the claims, as will be clear to the skilled reader, without departing from the spirit and scope of the invention.

1. A transceiver system comprising:
at least one receiver for receiving one or more signals from one or more transmitters, said one or more received signals having an associated chip rate, said receiver having:
at least one filter for selecting one or more input signals from the received signals;
a sequence extension remover for removing a predetermined number of chips from at least one predetermined position of said received signal to form a modified signal;
a despreader arranged to despread said received signal to a symbol rate and to form a despread signal, said symbol rate being less than said chip rate at which said received signal was spread prior to being received by said receiver, the ratio of the spread rate to the symbol rate being the processing gain of the receiver; and
a frequency domain equalizer arranged to form a frequency equalized signal from said despread signal.

2. A transceiver system according to claim 1, wherein said sequence extension remover has an input for receiving one or more signals output from said at least one filter, and said sequence extension remover has an output coupled to an input of said despreader.

3. A transceiver system according to claim 1, wherein said despreader has an input for receiving one or more signals output from said at least one filter, and said despreader has an output coupled to an input of said sequence extension remover.

4. A transceiver system according to claim 2, wherein said despreader has an output, and said frequency domain equalizer has an input, said despreader output being coupled to said input of said frequency domain equalizer.

5. A transceiver system according to claim 3, wherein said sequence extension remover has an output, and said frequency domain equalizer has an input, said output of said sequence extension remover being coupled to said input of said frequency domain equalizer.

6. A transceiver system according to claim 1, wherein said at least one receiver further comprises a first converter for converting the modified signal from a serial sequence to a parallel sequence, the first converter having an input coupled to an output of said at least one filter.

7. A transceiver system according to claim 1, wherein said at least one receiver further comprises a second converter coupled to an output of said frequency domain equalizer for converting the signal output from said frequency domain equalizer from a parallel sequence to a serial sequence.

8. The transceiver system according to claim 1, wherein said sequence extension remover is arranged to remove a predetermined number of chips carrying data denoting a cyclic prefix and/or a cyclic postfix.

9. The transceiver system according to claim 1, wherein said at least one receiver further comprises an orthogonal transform block for transforming said signal from a first domain to form a transformed signal in a second domain, said orthogonal transform block having an output coupled to an input of said frequency domain equalizer.

10. The transceiver system of claim 9, wherein said orthogonal transform block comprises a Fast Fourier Transform block.

11. The transceiver system of claim 10, wherein said first domain is the time domain and said second domain is the frequency domain.

12. The transceiver system of claim 1, wherein said at least one receiver comprises an inverse orthogonal transform block for transforming said signal from a second domain to a first domain, said inverse orthogonal transform block having an input coupled to an output of said frequency domain equalizer.

13. The transceiver system of claim 12, wherein said inverse orthogonal transform block comprises an Inverse Fast Fourier Transform block.

14. The transceiver system of claim 13, wherein said first domain is the time domain and said second domain is the frequency domain.

15. The transceiver system of claim 1, wherein said one or more filters are matched to a pulse shaping network in said transmitter.

16. The transceiver system according to claim 12, wherein said at least one receiver further comprises a deinterleaver block having an input coupled to an output of said inverse orthogonal transform block to form a deinterleaved signal to select one or more predetermined signals corresponding to predetermined users.

17. The transceiver system according to claim 1, wherein said frequency domain equalizer is arranged to equalize a frequency-selective fading channel to a non-frequency selective fading channel.

18. The transceiver system according to claim 1, wherein said at least one transmitter comprises:
at least one spreader for spreading a data packet having one or more blocks to derive a spread sequence for each of said blocks to form a spread signal, said spreader having an input and an output;
a sequence extender for extending each of said blocks using a predetermined number of chips to form an extended spread signal, said sequence extender being coupled to the output of the spreader, said sequence extender having an input and an output; and
a pulse shaper coupled to the output of said sequence extender.

19. The transceiver system according to claim 18, wherein said at least one transmitter comprises an interleaver for interleaving one or more modulated input signals from one or more users to produce an interleaved signal, said interleaver having an output coupled to an input of said at least one spreader.

20. The transceiver system according to claim 19, wherein said at least one transmitter further comprises a first converter for converting the interleaved signal from a serial sequence to a parallel sequence, the first converter having an output coupled to the input of said at least one spreader and an input connected to said output of said interleaver.

21. The transceiver system according to claim 18, wherein said at least one transmitter further comprises a second converter coupled between said spreader and said sequence extender for converting said spread signal from a parallel sequence to a serial sequence.

22. A transceiver system according to claim 1, wherein said at least one transmitter comprises:
a sequence extender for extending each of a number of blocks in an incoming signal using a predetermined number of chips to form an extended signal, said sequence extender having an output and an input, said incoming signal comprising at least one data packet;
at least one spreader for spreading said extended signal to derive a spread sequence for each of said blocks to form a spread signal, said spreader having an input and an output, said input of said spreader being coupled to said output of said sequence extender; and
a pulse shaper coupled to the output of said spreader to provide a transmitter output signal.

23. A transceiver system according to claim 22, wherein said at least one transmitter further comprises a first converter for converting the incoming signal from a serial sequence to a parallel sequence, the first converter having an output coupled to the input of said sequence extender.

24. A transceiver system according to claim 23, wherein said at least one transmitter further comprises an interleaver for receiving one or more modulated input signals from one or more users, said interleaver having an output coupled to an input of said first converter.

25. A transceiver system according to claim 22, wherein said at least one transmitter further comprises a second converter having an input coupled to the output of said spreader for converting the signal output from said spreader from a parallel sequence to a serial sequence, the second converter having an output coupled to an input of said pulse shaper.

26. A transceiver system according to claim 22, wherein said pulse shaper matches the filter of said at least one receiver.

27. A method for transmitting signals, said method comprising the steps of:
spreading, by at least one spreader, a data packet having one or more blocks to derive a spread sequence for each of said blocks and to form a spread signal;
extending, by a sequence extender, each of said blocks in said spread signal using a predetermined number of chips to form an extended spread signal, said spread signal being received from a spreader output of said at least one spreader;
shaping, by a pulse shaper coupled to an output of said sequence extender, said extended spread signal; and interleaving, in at least one interleaver, one or more modulated input signals from one or more users to form an interleaved signal, before the spreading step

28. (canceled)

29. The method of claim 27, further comprising converting, in a first converter, the interleaved signal from a serial sequence to a parallel sequence, before the spreading step.

30. The method of claim 27, further comprising converting said spread signal from a parallel sequence to a serial sequence before the extending step.

31. A method for transmitting signals, said method comprising the steps of:
extending, by a sequence extender, each of a number of blocks in an incoming signal using a predetermined number of chips to form an extended signal, said incoming signal comprising at least one data packet;
spreading, in at least one spreader, said extended signal received from an output of said sequence extender to derive a spread sequence for each of said blocks to form a spread signal; and
shaping, in a pulse shaper, said spread signal received from an output of said at least one spreader to provide a transmitter output signal.

32. The method of claim 31, further comprising the step of converting the incoming signal from a serial sequence to a parallel sequence before the extending step.

33. The method of claim 31, further comprising interleaving, in at least one interleaver, said one or more modulated input signals from one or more users to form an interleaved signal, prior to the extending step.

34. The method of claim 31, further comprising converting said spread signal, received from said spreader, from a parallel sequence to a serial sequence, prior to the pulse shaping step.

35. The method of claim 34, further comprising shaping said signal using a pulse shaper which matches a input filter of at least one receiver.

36. A method for processing a received signal comprising the steps of:
receiving one or more signals from one or more transmitters, said one or more received signals having an associated chip rate;
selecting, using at least one filter, one or more input signals from the received signals;
removing, in at least one sequence extension remover, a predetermined number of chips from at least one predetermined position of said received signal to form a modified signal;
despreading, in at least one despreader, said received signal to a symbol rate and to form a despread signal, said symbol rate being less than said chip rate at which said received signal was spread prior to being received by said receiver, the ratio of the spread rate to the symbol rate being the processing gain of the receiver; and
forming, in at least one frequency domain equalizer, a frequency equalized signal from said despread signal.

37. A method according to claim 36, wherein said step of removing said sequence extension is before said despreading step and after said selecting step.

38. A method according to claim 36, wherein said despreading step is before said step of removing said sequence extension and after said selecting step.

39. A method according to claim 38, wherein the step of removing said sequence extension is before said step of forming, in at least one frequency domain equalizer, a frequency equalized signal and after said despreading step.

40. A method according to claim 37, wherein the despreading step is before the step of forming the frequency equalized signal.

41. A method according to claim 36, further comprising converting the modified signal from a serial sequence to a parallel sequence after the selecting step.

42. A method according to claim 36, further comprising converting the frequency equalized signal from a parallel sequence to a serial sequence.

43. The method of claim 36, wherein the step of removing said sequence extension comprises removing a predetermined number of chips carrying data denoting a cyclic prefix and/or a cyclic postfix.

44. The method of claim 36, further comprising transforming in an orthogonal transform block said signal from a first domain to form a transformed signal in a second domain, before the step of forming said frequency equalized signal.

45. The method of claim 44, wherein said transforming step comprises applying a Fast Fourier Transform process to said signal.

46. The method of claim 44, wherein said transforming step comprises transforming said signal from the time domain to the frequency domain.

47. The method of claim 36, further comprising applying, after the step of forming a frequency equalized signal, applying an inverse orthogonal transformation to said signal for transforming said signal from a second domain to a first domain.

48. The method of claim 47, wherein the step of applying an inverse orthogonal transformation comprises applying an Inverse Fast Fourier Transform process.

49. The method of claim 47, wherein the step of applying an inverse orthogonal transformation comprises transforming the signal from the time domain to the frequency domain.

50. The method of claim 36, further comprising matching said at least one filter to a pulse shaping network in a transmitter.

51. The method of claim 47, further comprising deinterleaving said inverse orthogonally transformed signal to select one or more predetermined signals corresponding to predetermined users to form a deinterleaved signal.

52. The method of claim 36, wherein the step of forming a frequency equalized signal comprises equalizing a frequency-selective fading channel to a non-frequency selective fading channel.

53. A code division multiple access (CDMA) system comprising at least one transceiver system according to claim 1.

54. An ultrawide band (UWB) system comprising at least one transceiver system according to claim 1.
